(19) United States
(12) Patent Application Publication
(10) Pub. No.: US 2024/0281660 A1
(43) Pub. Date: Aug. 22, 2024

(54) DEEP LEARNING SYSTEMS, DEVICES AND METHODS FOR PREDICTING USER CONTENT ENGAGEMENT

(71) Applicant: PARHAM AARABI, RICHMOND HILL, CA (US)

(72) Inventor: PARHAM AARABI, RICHMOND HILL, CA (US)

(21) Appl. No.: 18/397,646

(22) Filed: Dec. 27, 2023

Related U.S. Application Data
(60) Provisional application No. 63/447,226, filed on Feb. 21, 2023.

(51) Int. Cl. G06N 3/084

(52) U.S. Cl. CPC G06N 3/084

(57) ABSTRACT

Methods and systems are provided for estimating the selection probability of a digital object on a website or application by a human based on features extracted from an image, a video, or input text description of the object by a user. A communication interface receives the input from the user. Memory is provided for storing a neural network model, selection probability prediction and training data, the training data including a first training dataset and a second training dataset. The neural network model is trained in a pre-training step with the first training dataset and is followed by a fine-tuning step with the second training dataset to obtain a multi-layer neural network. Input is provided to the multi-layer neural network to obtain a classification vector. Based on the classification vector, a selection probability prediction is calculated and delivered to the user through the communication interface.

### CROSS-REFERENCE

This application claims a domestic benefit of U.S. Prov. No. 63/447,226, filed Feb. 21, 2023, and entitled, “SYSTEM AND METHOD FOR HUMAN BEHAVIOUR PREDICTION”, the entire contents of which are incorporated herein by reference.

### FIELD OF INVENTION

This application relates to improvements to computer processing of images and natural language using deep learning and more particularly to deep learning image and natural language processing systems, devices and methods, including such for predicting user interface engagement with user interface objects or engagement with social media content.

### BACKGROUND OF INVENTION

Natural language processing (NLP) using deep learning systems such as artificial intelligence-based deep learning networks are improving operations of computers through deeper and more meaningful learning about human language. Large language models encode a deep understanding of language through training on a large corpus of data. Uses of such models include generative applications that enable a computer to produce natural language output, for example, generating an output in response to a question. Language models can provide meaningful responses to questions not observed during training due the model's language understanding an abstraction. Language models are ripe for integration into additional contexts.

Human users of computer applications and/or websites (sometimes hereinafter “app/site” in the singular and “app/sites” in the plural) are often presented with options including buttons, banners, advertisements, visuals, images, video or other user interface objects which they may or may not click or tap on. There is value in improving or optimizing user engagement with an app/site and a desire to know a probability of a user engaging (e.g. by clicking or tapping, etc.) with a particular object.

### SUMMARY

Knowing the probability of a human user clicking or tapping on a particular object provides app/site owners the ability to, any one or more of 1) simulate the performance of their app/sites, 2) optimize their app/site by updating one or more objects and measuring the difference in simulation results, or 3) allow them to modify traffic to a particular application interface or web page by updating its corresponding inbound objects that link thereto. Human behaviour prediction on app/sites, including e-commerce app/sites, can be very beneficial for performance optimization. Furthermore, such a predictive capability could be used to measure the efficacy of different advertisements or banners prior to actual implementation/usage. Systems and methods are described herein for predicting user behaviour in websites or applications, including the probability of a user selecting an option from a group of objects within a website or application, based on features extracted from a text description or image of each object. The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

Aspects and features disclosed herein include those in the following numbered statements:

Statement 1: A computer-implemented method for estimating the probability of selection of a website or application user interface object by a human based on features extracted from an input description of the object from a user, the method comprising: obtaining a multi-layer neural network comprising a neural network model pre-trained with an unlabeled training dataset; fine-tuning the neural network model with a labeled dataset, the labeled dataset comprising data tagged with one or more classes; receiving the input description of the object, or an image input or a video input of the object through a communication interface; providing the input to the multi-layer neural network to obtain a classification vector, the classification vector having one or more entries, wherein each of the one or more entries is associated with a class of the feature; and based on the classification vector, estimating the probability of selection of the object contained by or described by the input.

Statement 2: The method of Statement 1, wherein the neural network model is multiversally trained with the labeled dataset filtered to form a subset of the labeled dataset, and wherein the subset of the labeled dataset is used for fine-tuning the neural network model.

Statement 3: The method of Statement 1 or 2, wherein the labeled training dataset is smaller than the unlabeled training dataset.

Statement 4: The method of any one of Statements 1 to 3, wherein the pre-training comprises bidirectional training by applying a missing words mask to the unlabeled dataset.

Statement 5: The method of any one of Statements 1 to 4, wherein the pre-training comprises training through sentence prediction.

Statement 6: The method of any one of Statements 1 to 5, wherein the fine-tuning comprises training through back-propagation.

Statement 7: The method of any one of Statements 1 to 6, wherein the selection probability estimate is obtained by taking the product of the likelihood of each class with the selection probability associated with the class, and the summation of the resulting products.

Statement 8: The method of any one of Statements 1 to 7, wherein the input is a text string, and wherein the feature extracted from the input is a text description of a website or application user interface object.

Statement 9: The method of any one of Statements 1 to 8, wherein the selection probability estimate is obtained by taking a dot product between the class selection probability vector and the classification result vector.

Statement 10: A non-transitory computer-readable medium comprising instructions executable by a processor to perform a method according to any one of Statements 1 to 9.

Statement 11. A system for estimating the probability of selection of a website or application user interface object by a human based on features extracted from an input from a user, the system comprising: a communication interface for receiving the input from the user; one or more memory storage for storing a neural network model, probability of selection estimate, the training data comprising an unlabeled training dataset and a labeled training dataset, the labeled dataset including data tagged with one or more classes; and a processor configured to: train the neural network model using the training data to obtain a multi-layer neural network, the neural network model trained in a pre-training step with the unlabeled training dataset and fine-tuned with the labeled training dataset; provide the input to the multi-layer neural network to obtain a classification vector, the classification vector having one or more entries, wherein each of the one or more entries is associated with a class of the feature; and based on the classification vector, estimate the probability of selection of a website or application object that was described or contained by the input.

Statement 12: The system of Statement 11, wherein the processor is configured to multiversally filter the labeled dataset to obtain a subset of the labeled dataset, and wherein the subset of the labeled dataset is used in the fine-tuning of the neural network model.

Statement 13: The system of Statement 11 or 12, wherein the labeled training dataset is smaller than the unlabeled training dataset.

Statement 14: The system of any one of Statements 11 to 13, wherein the pre-training step comprises bidirectional training by applying a missing words mask to the unlabeled dataset.

Statement 15: The system of any one of Statements 11 to 14, wherein the pre-training step further comprises training through sentence prediction.

Statement 16: The system of any one of Statements 11 to 15, wherein the fine-tuning of the neural network model comprises training through back-propagation.

Statement 17: The system of any one of Statements 11 to 16, wherein the input is a text string describing a user interface object, and wherein the feature extracted from the input is the probability of selection by a human of a user interface object described by the input text string.

Statement 18: The system of any one of Statements 11 to 17, wherein the selection probability estimate is obtained by taking a dot product between the class selection probability vector and the classification result vector.

Statement 19: The method of claim 1 comprising pre-training the neural network model with the unlabeled training dataset.

Statement 20: A system providing a neural network model trained in accordance with training steps recited in any one of Statements 1 to 9 and 19; and an interface that: i) receives the input description or the image or video input containing the object for processing by the neural network model and ii) provides the estimate.

Statement 21: The system of Statement 20, wherein the neural network model as fine trained is provided in a software-as-a-service (SaaS) model to evaluate user interfaces of an application or website.

In addition to the exemplary aspects and embodiments described above, further aspects and embodiments will become apparent by reference to the drawings and by study of the following detailed descriptions.

### BRIEF DESCRIPTION OF THE DRAWINGS

Features and advantages of the embodiments of the present invention will become apparent from the following detailed description, taken with reference to the appended drawings in which:

FIG. 1 is a block diagram of an example embodiment of a system to estimate the probability of selection of a user interface object by a human by natural language processing of text input using a trained multi-layer neural network.

FIG. 2 is a block diagram of an embodiment of a trained multi-layer neural network of the FIG. 1 system.

FIG. 3 is a flowchart illustrating, in accordance with an embodiment, a method of training a neural network model followed by using the trained neural network to obtain a classification vector from text input.

### DETAILED DESCRIPTION

The description, which follows, and the embodiments described therein, are provided by way of illustration of examples of particular embodiments of the principles of the present invention. These examples are provided for the purposes of explanation, and not limitation, of those principles and of the invention.

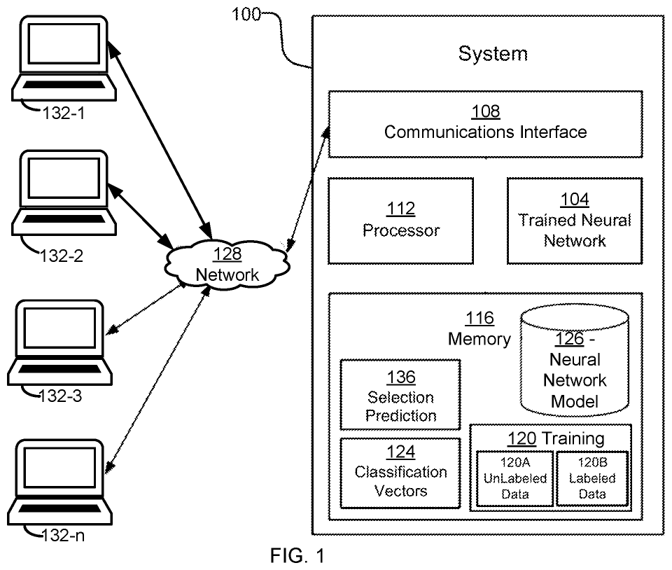

FIG. 1 depicts an example embodiment of a system 100 for estimating the probability of selection by a human of an app/site user interface object (e.g., a button, a banner, an advertisement, a picture, a video, etc.) based on features or characteristics of the object (e.g., emotion, color, promotion, time sensitivity, etc.) extracted from a natural language based input such as a text input that describes the object, with said description including but not limited to the text, size, color, contents (e.g. add to cart button), actionability, and promotional specifications (e.g. 20% sale). While the description herein is primarily in the context of text input, it will be appreciated that audio input such as a speech input could be used, which audio and or voice input is pre-processed to produce text (e.g. using speech to text techniques). A feature may be associated with a class using classes (e.g. highly unlikely, unlikely, neutral, likely, very likely, etc.), with these labels obtained based on analytics and/or interaction data obtained from other user sessions on the same or other sites/apps. In an embodiment prior interaction data (from the same or other apps/sites) is used to classify a set of app/site elements (e.g. objects) to define the training data. In an embodiment, system 100 includes multi-layer neural network 104, communications interface 108, processor 112, and memory 116. Trained multi-layer neural network 104 (which may be shown in memory 116 in an embodiment (not shown)) is configured to extract or otherwise determine one or more features of interest from the input. As described in more detail below, in an embodiment multi-layer neural network 104 may be trained in a two-step process involving a first step of pre-training and a second step of fine-tuning. In an embodiment, a pre-trained model is obtained and fine-tuned. In an embodiment an untrained model is received and pre-trained, followed by fine-tuned.

System 100 may be implemented by a server that includes a server processor, a server memory storing instructions executable by the system processor, a system communications interface, input devices, and output devices. Reference herein to a system includes one or more systems such as one or more servers. Reference herein to a system processor includes one or more system processors, which may be configured on one or more systems (e.g. on one or more servers).

Communications interface 108 comprises electronics that allow system 100 to connect to other devices such as client computers 132. Client computers 132-1, 132-2, 132-3 . . . 132-n are referred to herein individually as client computer 132 and collectively as client computers 132. Communications interface 108 can also connect system 100 to input and output devices (not shown) via another computing device. Examples of input (I) devices include, but are not limited to, a keyboard and a mouse. Examples of output (O) devices include, but are not limited to, a display showing a user interface. Examples of input/output (I/O) devices include touch enabled display devices. The input, output and/or (I/O) devices can be local to system 100 and connect directly to processor 112, or input and/or output devices can be remote to system 100 and which connect to system 100 through another computing device via communications interface 108.

Processor 112 can train and instruct multi-layer neural network 104 to determine the features of interest from the input. Processor 112 can also, based on the features of interest, estimate a selection probability 136 of a user interface object e.g. by a human. In one embodiment, this estimate is a function of the classification results. For example, if the classification has 5 values of A) highly unlikely, B) unlikely, C) neutral, D) likely, and E) highly likely, then one possible formula to estimate the probability would be:

$$\\ P = Object Probability Estimate = - 50 \% X [ A ] - 25 \% X [ B ] + 25 \% X [ D ] + 50 \% X [ E ]$$

where X[i] is the classification result for class i (in one embodiment, on a 0-1 scale). More generally, each classification likelihood can be weighted by the selection probability percentage corresponding to the class. This is accomplished as follows:

$$\\ P = Object Probability Estimate = \sum M [ i ] X [ i ]$$

where the summation 2 above is performed over all the classes i, where M[i] is the corresponding probability percentage for class i (e.g. for i=“likely”, M[i] could be +25%), and X[i] is the classification result for class i as before. In this embodiment, the object probability estimate can be viewed as the algebraic dot product between the class probability vector M and the classification result vector X, such that P=M·X.

Memory 116 stores the prediction probability estimate 136, neural network model 126, training datasets 120, and data generated from neural network 104 (e.g., classification vectors 124) as described in more detail below. Memory 116 includes a non-transitory computer-readable medium that may include volatile storage, such as random-access memory (RAM) or the like, and may include non-volatile storage, such as a hard drive, flash memory, or the like.

As depicted in FIG. 1, system 100 may be in communication with at least one client computer 132 through a network 128. Client computer 132 can provide a graphical user interface (GUI) or a front-end for users to provide inputs (e.g., text, voice, image, video, etc. of the user interface to be analyzed) to system 100. Client computers 132 transmit inputs provided by users to system 100 and/or receive outputs (e.g., a selection probability estimate) from system 100. Client computer 132 may display the output received from system 100 to the user in some cases. Client computers 132 may include desktop computers, laptop computers, servers, or any other suitable device operable by users to provide inputs. Client computers 132 may also include mobile computing devices, such as tablets, smart phones, smart watches, or the like. An example client computer 132 may include a processor, a memory storing instructions executable by the processor, a communications interface, input devices, and output devices. Although not necessary, client computers 132 can form a part of system 100 in some cases.

Client computers 132 are connected directly or indirectly to multi-layer neural network 104 of system 100 via network 128. Network 128 can include any one or any combination of: a local area network (LAN) defined by one or more routers, switches, wireless access points or the like, any suitable wide area network (WAN), cellular networks, the internet, or the like. Although not necessary, network 128 can form a part of system 100 in some cases. For example, system 100 may comprise its own dedicated network 128.

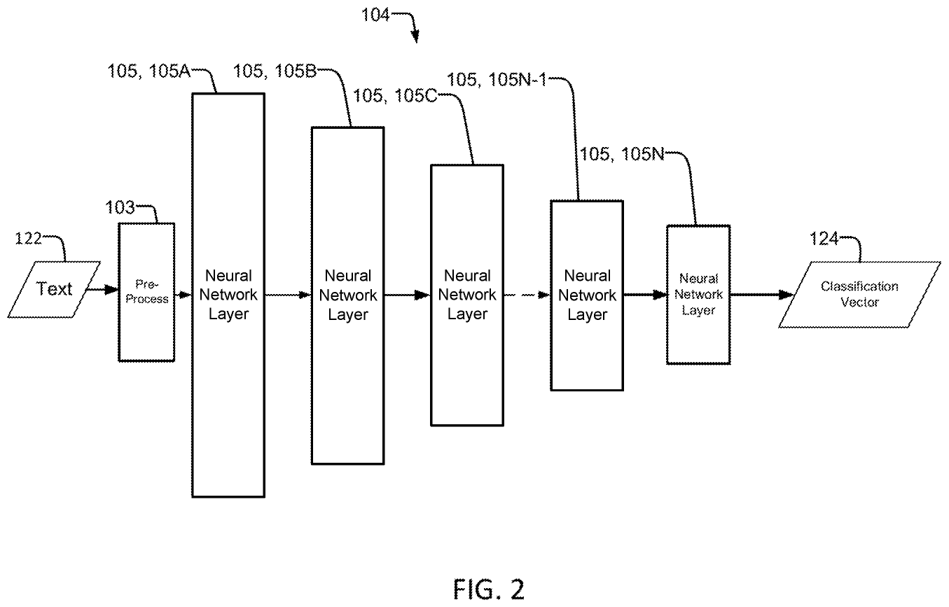

FIG. 2 is a block diagram of a multi-layer neural network 104 according to an example embodiment of the invention. Neural network 104 may be implemented by memory 116 and processor 112 of system 100, or dedicated hardware such as graphical processing units (GPUs), hardware accelerators, etc. Neural network 104 comprises neural network layers 105A, 105B, . . . , 105N, including an input layer 105A, intermediate layers 105B, 105C, . . . , 105N-1, and an output layer 105N (collectively 105). Each of the neural network layers 105 comprises its own respective nodes (not shown) that are configured to perform computations in parallel with one another (e.g., weighted summation, multiplication by an activation function, etc.). Neural network 104 may also comprise a pre-processing module 103 for converting an input such as text 122 into a suitable form for processing at layer 105A, or a pre-pre-processing component such as to convert another input to text (not shown).

In an embodiment, neural network 104 is trained in a two-step process. The two-step process may involve a first step of pre-training on a relatively large dataset to obtain a NLP model and a second step of fine-tuning on a relatively small dataset to obtain the final classifier model. For brevity, the first step may also be referred to herein as “pre-training” and the second step may also be referred to herein as “fine-tuning”. As described in more detail below, pre-training may be performed using a large corpus of unlabeled text to understand language. Fine-tuning may be performed using labeled text (e.g., text with an associated classification feature vector such as classes of probability of selection of an object (e.g. unlikely, likely, etc.)) to understand the relation between the language and certain features of interest. In an embodiment, pre-training is performed by one entity and a second entity obtains a pre-trained NLP model and performs fine-tuning thereof, to additionally train the pre-trained NLP model for classification such as described further herein. The pre-trained model can be adapted with network layers defining the classifier, as may be necessary. An example of a pre-trained NLP model is described in “BERT: Pre-training of deep bidirectional transformers for language understanding”. (Devlin, J. et al., June 2019 In Proceedings of NAACL-HLT 2019, pp. 4171-4186) which is incorporated herein by reference.

By combining pre-training with fine-tuning, neural network 104 may be trained to form some layers 105 that mostly learn a language model (e.g. the encoder) and other layers 105 that mostly act as the classifier 106 (the decoder). Namely, trained neural network 104 may include a first set of layers 105 configured to implement primarily a language model and a second set of layers 106 configured to implement primarily a classifier. In some embodiments, the intermediate layers 105B, . . . , 105N-1 of neural network 104 can include layers 105 from both the first set and the second set. Illustratively, combining language model 105 with classifier 106 in accordance with methods described herein allows trained neutral network 104 to extract feature(s) of interest from an input in a more accurate manner and/or to extract feature(s) of interest from a wider variety of inputs.

In some embodiments, neural network 104 is trained or otherwise configured to receive input text 122, extract features of interest from input text 122, and output the extracted features of interest. To extract features of interest from text 122, trained neural network 104 may perform, at a pre-processing module 103, one or more of: tokenizing text 122 (e.g., splitting text 122 to words), adding one or more tokens to text 122 (e.g., at the beginning and/or end of a sentence), encoding the tokenized text 122 into a numerical representation, and inputting the numerical representation of text 122 to first layer 105A of neural network 104. For example, pre-processing module 103 may tokenize and convert input text 122 into a numeric vector and the numeric vector may then be inputted to first layer 105A of neural network 104. Such numeric vectors may have a length corresponding to the number of nodes of input layer 105A.

In some embodiments, trained neural network 104 is configured to extract or otherwise determine the probability of selection of an app/site's user interface object by a human from input text 122 describing the object. In such embodiments, neural network 104 may be trained or otherwise configured to output a classification vector 124 characterizing the selection probability of the object inferred from input text 122. Classification vector 124 may comprise an array of numbers, with each number representing the likelihood of a particular selection probability (e.g. highly unlikely, likely, neutral, etc.). For example, neural network 104 may be trained to output a classification vector 124 having eleven elements corresponding to the following classes of selection probability [0%10%20%30%40%50%60%70%80%90%100%]. In such embodiments, neural network 104 may, for example, in response to a text input 122 of “a colorful visual featuring a popular product at a large discount” output a classification vector 124 of [0,0,0,0,0,0,0,0,0,1,0] (i.e. a 90% probability of selection).

The output classification vector 124 may be stored in memory 116 of system 100 for further processing.

In some embodiments, neural network 104 is trained or otherwise configured to output classification vectors 124 containing numbers that add up to 1. In such embodiments, classification vector 124 can represent a varying mixture of selection probabilities, quantified as percentages, associated with input text 122.

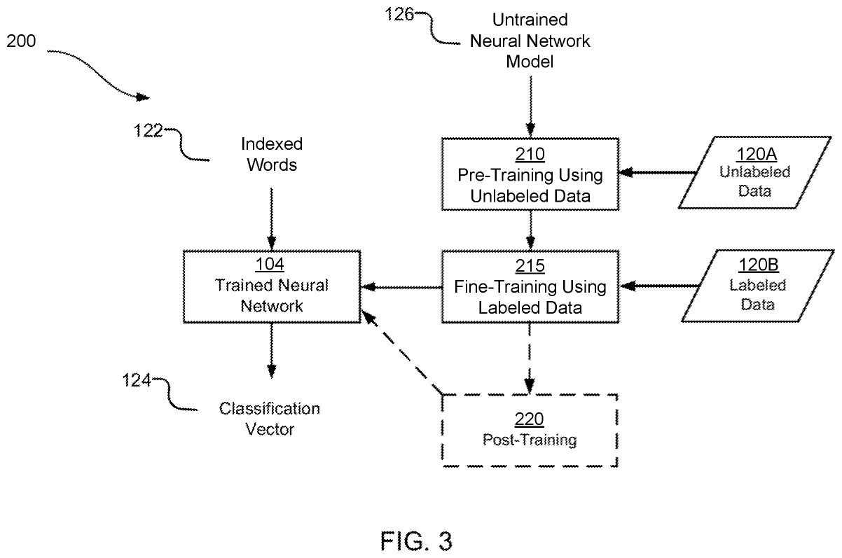

Further aspects of the invention relate to methods of obtaining multi-layer neural network 104 from an untrained neural network model 126. FIG. 3 is a flowchart illustrating an example method 200 of obtaining multi-layer neural network 104 from neural network model 126. Method 200 may be implemented via processor 112 and/or memory 116. Method 200 involves training neural network model 126 using a training dataset 120 comprising both unlabeled data 120A (e.g., text description strings without corresponding object selection probabilities associated therewith) and labeled data 120B (e.g., text description strings with corresponding object selection probabilities associated therewith). Training dataset 120 may be developed using a multi-layer bidirectional transformer encoder, or the like. For example, training dataset 120 may be developed using techniques described in “Attention is all you need” (Vaswani Ashish, et al. December 2017. In Proceedings of the 31st International Conference on Neural Information Processing Systems (Long Beach, California, USA) (NIPS′17). Curran Associates Inc., Red Hook, NY, USA, pp. 6000-6010.), which is incorporated herein by reference.

In the illustrated embodiment, method 200 comprises obtaining at pre-training step 210 a natural language prediction model. In one example embodiment, such natural language prediction model may be similar to or based on a Bidirectional Encoder Representations from Transformers model described in “BERT: Pre-training of deep bidirectional transformers for language understanding”. (Devlin, J. et al., June 2019 In Proceedings of NAACL-HLT 2019, pp. 4171-4186) which is incorporated herein by reference.

Pre-training step 210 comprises one or more passes at training neural network model 126 using unlabeled data 120A. In a first pass at training in step 210, words from unlabeled training data 120A may be tokenized via a word-to-index convertor or lookup table. First pass training may be performed in a bidirectional fashion by first applying a missing words mask to the unlabeled training data 120, and then training neural network model 126 to predict the missing word in the missing word mask. In some embodiments, the missing word mask is applied by randomly selecting a subset of the unlabeled training data 120A and replacing certain words from the subset with a token. For example, a missing word mask can be applied to the sentence “cold ice cream” to yield “cold ______cream”, and neural network model 126 may be trained to return the token for the word “ice” when “cold ______ cream” is inputted to neural network model 126.

In an optional second pass at training in step 210, next sentence prediction can be used. Next sentence prediction involves training neural network model 126 to predict, based on the tokens in a first sentence, the tokens in a following sentence (i.e., a second sentence). For example, next sentence prediction can be applied to the sentence “The weather is cold outside today” (e.g., a sentence from unlabeled data 120A) to train neural network model 126 to return the tokens for the words “bring” and “coat” as part of predicting the second sentence to be “I should bring a coat”.

Optionally, pre-training step 210 may comprise or be followed by a pre-filtering step. The optional pre-filtering step involves selecting more robust or more meaningful labeled data 120B and rejecting noisy or erroneous data. The pre-filter step can be performed by going through the data and selecting only the data elements that are determined to be valid in a knowledge distillation step where pre-trained neural network model 126 (a large and complex language model) is distilled. The knowledge distillation may involve using a parent model to teach a smaller student model. Illustratively, the student model may be a simpler model with similar performance and accuracy as compared to the parent model.

After pre-training neural network model 126 with a natural language prediction model in step 210 to obtain language model 105 or portions thereof, method 200 proceeds to a fine-tuning step 215. In a current embodiment, fine-tuning step 215 comprises providing labeled training data 120B to the pre-trained neural network model 126 to further train (i.e., to “fine tune”) neural network model 126 using methods such as back-propagation or similar error-based training methods. The amount of labeled training data 120B required can be relatively small compared to the amount of unlabeled training data 120A. Labeled training data 120B includes text description strings for an object along with the associated probability of selection of that object by a human in an app/site, which may be expressed as a text response or a vector like the classification vector 124. For example, one labeled training data 120B may contain the text string “A bright red button” and an associated selection probability of 20%. In this example, the 20% selection probability may be expressed as the vector [0,1,0,0,0,0] corresponding to [0%,20%,40%, 60%,80%, 100%].

In some embodiments, step 215 comprises training all of the neural network layers that were pre-trained at step 210. In other embodiments, step 215 comprises training neural network layers that were pre-trained at step 210 as well as the additional neural network layers (e.g., neural network layers that were not trained at step 210), such as for use to fine tune (e.g. adapt) a model. Thus, both the pre-trained neural network layers and the additional neural network layers are fine-tuned during step 215 in such embodiments. In other embodiments, step 215 comprises training only the additional neural network layers that were not pre-trained at step 210. Thus, in these embodiments, only the additional neural network layers are fine-tuned in step 215 in such embodiments.

After step 215, the training of multi-layer neural network 104 is complete. Thus the fine-tuning improves and leverages capabilities of natural language processing models and thus computers themselves. In the present embodiment, the fine tuning enables the deep learning based NPL models (and methods and systems incorporating same) to predict an action (e.g. a user behavior) from processing a natural language-based input. In the embodiment, the predicted behavior is a likelihood of a user engagement with an interface object.

Therefore, illustratively, multi-layer neural network 104 allows system 100 to estimate selection probabilities from a wide variety of object description text, including text that is not within the vocabulary of the smaller labeled dataset 120B. As an example, the phrase “a colorful button” may not be contained in the labeled text dataset 120B. Typical systems would not be capable of identifying an appropriate selection probability for such a phrase because they have not been properly trained to recognize such a phrase. However, by first learning a language, multi-layer neural network 104 is able to identify closely associated phrases such as “a vibrant visual”, or “an object that visually stands out”, or “an attention grabbing button”. Since at least one of the closely associated phrases will likely be contained in the labeled dataset 120B, multi-layer neural network 104 will be able to extract a selection probability from the phrase “a colorful button” and assign a corresponding classification vector 124 thereto (even though this phrase does not exist within the vocabulary of labeled training dataset 120B).

Method 200 may optionally comprise a post-training step 220 for further optimization of trained neural network model 104. In some embodiments, step 220 comprises performing multiversal training to specifically focus on a part of the training data for the trained neural network 104. This could, in one embodiment, be used to only use selection probabilities from a specific demographic (e.g. older user, female users, etc.).

Referring back to FIG. 3, trained neural network 104 may be used by system 100 to extract a classification vector 124 from a text input 122. Once classification vector 124 has been extracted from trained neural network 104, processor 112 may calculate the probability of selection of an object described by the text input 122 based on the classification vector.

Aspects of the invention may be applied more broadly to applications beyond object selection probability prediction. For example, systems and methods described herein may be use for any application where text is classified, as described in more detail below.

Further aspects of the invention are described with reference to the following example applications, which are intended to be illustrative and not limiting in scope.

In one example application, system 100 is used to provide a system for the estimation of the efficacy of banner advertisements by obtaining a text input of the advertisements and generating a prediction of the probability of selection of the advertisement (i.e. the click rate) by humans. By performing this for multiple advertisements, it becomes possible to choose an advertisement with the highest selection probability. In another example, operations can define a website or application user interface object; determine a classification result for the object from input text for the object as processed by the trained classifier; and refine the object (e.g. to improve or optimize its features) in response to the classification result. In another example, operations can define an asp/site user interface to include an interface object in response to a probability of selection or other classification result as determined for the interface object using the trained classifier.

In another example application, system 100 is used to estimate the selection probabilities of different user interface elements (e.g. buttons, banners, images, videos, etc.) of a website by a human as part of a larger website simulation. By knowing the selection probabilities of each element within the site, along with the placement and size of the user interface elements in addition to the link associated with each element, it becomes possible to artificially simulate the effect of human traffic on the website, including measurement of key performance metrics including but not limited to cart rate, conversions, bounce rate, and revenue per user. This is done by repeating simulated sessions with virtual users navigating the site in a simulation. After a large number of virtual sessions, there is produced statistically relevant information about the percent of users who added a product to cart, who purchased a product, and the average revenue per user generated. These statistics become a reasonable estimate which can be used as an indication of the performance of the site.

Illustratively, computerized detection of features from text is more accurate with one or more neural networks trained in accordance with the techniques described herein. By training a neural network model using a training set comprising both unlabeled data and labeled data, the trained neural network may be able to determine human behaviour more accurately. By including trained neural networks described herein, systems are able to provide more meaningful interactions with human users. This may help facilitate more natural and engaging conversations between humans and machines.

It should be recognized that features and aspects of the various examples provided above can be combined into further examples that also fall within the scope of the present disclosure. In addition, the figures are not to scale and may have size and shape exaggerated for illustrative purposes.

In practice, as one practical embodiment, the proposed system can be implemented as a software as a service running on one or more computers, accessed by one or more operators that can direct the service to analyze, simulate, and measure the performance of a particular site or application. In this embodiment, the simulation of the site would occur on a computer or server with the simulation parameters stored in memory. The operators can then obtain the statistically relevant data from the simulations in order to make decisions about the performance of the site.

In another embodiment, the system described above would consist of a pre-trained deep neural network (such as the TinyVGG architecture: Wang, Z. J., Turko, R., Shaikh. O., Park, H., Das. N., Hohman. F., Kahng, M. and Chau, D. H., 2020 April. CNN 101: Interactive visual learning for convolutional neural networks. In Extended abstracts of the 2020 CHI conference on human factors in computing systems (pp. 1-7).) along with the fine-tuning step in order to predict the affinity related to UI element images/videos or social media image or video posts.

TinyVGG is a variant of the VGG (Visual Geometry Group) network, known for its deep architecture and strong performance in image classification tasks. It typically comprises a series of convolutional layers followed by fully connected layers. However, TinyVGG is a more lightweight version designed to be computationally efficient while maintaining reasonable accuracy.

The architecture may consist of several convolutional blocks, each composed of convolutional layers with small kernel sizes (e.g., 3×3), followed by max-pooling layers to downsample the spatial dimensions. These blocks are usually followed by fully connected layers before the final output layer for classification or regression.

### Training Process:

The training process involves feeding the deep learning model with a large dataset of images labeled with their corresponding engagement rates or metrics (likes, shares, views, etc.). The model learns to extract features from these images and correlates them with the provided engagement data.

Training a deep neural network like TinyVGG can be achieved, in one embodiment, by using optimization techniques like stochastic gradient descent (SGD) or its variants. The model learns by minimizing a loss function, which measures the difference between predicted engagement rates and actual engagement values. This process continues through multiple iterations (epochs) until the model converges to a state where it accurately predicts engagement metrics.

Practical implementation may include any or all of the features described herein. These and other aspects, features and various combinations may be expressed as methods, apparatus, systems, means for performing functions, program products, and in other ways, combining the features described herein. A number of embodiments have been described. Nevertheless, it will be understood that various modifications can be made without departing from the spirit and scope of the processes and techniques described herein. In addition, other steps can be provided, or steps can be eliminated, from the described process, and other components can be added to, or removed from, the described systems. Accordingly, other embodiments are within the scope of the following claims.

Throughout the description and claims of this specification, the word “comprise”, “contain” and variations of them mean “including but not limited to” and they are not intended to (and do not) exclude other components, integers or steps. Throughout this specification, the singular encompasses the plural unless the context requires otherwise. In particular, where the indefinite article is used, the specification is to be understood as contemplating plurality as well as singularity, unless the context requires otherwise.

Features, integers, characteristics, or groups described in conjunction with a particular aspect, embodiment or example of the invention are to be understood to be applicable to any other aspect, embodiment or example unless incompatible therewith. All of the features disclosed herein (including any accompanying claims, abstract and drawings), and/or all of the steps of any method or process so disclosed, may be combined in any combination, except combinations where at least some of such features and/or steps are mutually exclusive. The invention is not restricted to the details of any foregoing examples or embodiments. The invention extends to any novel one, or any novel combination, of the features disclosed in this specification (including any accompanying claims, abstract and drawings) or to any novel one, or any novel combination, of the steps of any method or process disclosed.

### REFERENCES

The following references are incorporated by reference in their respective entireties.
Attention is all you need. Vaswani, A., et al. December 2017. In Proceedings of the 31st International Conference on Neural Information Processing Systems (Long Beach, California, USA) (NIPS′17). Curran Associates Inc., Red Hook, NY, USA, pp. 6000-6010, or arXiv: 1706.03762
BERT: Pre-training of deep bidirectional transformers for language understanding. Devlin, J. et al., June 2019 In Proceedings of NAACL-HLT 2019, pp. 4171-4186, or arXiv: 1810.04805
CNN 101: Interactive visual learning for convolutional neural networks. Wang, Z. J., Turko, R., Shaikh, O., Park, H., Das, N., Hohman, F., Kahng, M. and Chau, D. H., April 2020, In Extended abstracts of the 2020 CHI conference on human factors in computing systems (pp. 1-7) or arXiv:2001.02004
Very Deep Convolutional Networks for Large-Scale Image Recognition. Simonyan, K and Zisserman, A. (2014), arXiv:1409.1556

1. A computer-implemented method for estimating the probability of selection of a website or application user interface object by a human based on features extracted from an input description of the object, or an image input or a video input of the object from a user, the method comprising:
obtaining a pre-trained multi-layer neural network comprising a neural network model pre-trained with an unlabeled training dataset;
fine-tuning the neural network model with a labeled dataset, the labeled dataset comprising data tagged with one or more classes;
receiving the input description, or the image input or the video input of the object through a communication interface;
providing the input to the multi-layer neural network to obtain a classification vector, the classification vector having one or more entries, wherein each of the one or more entries is associated with a class of the feature; and
based on the classification vector, estimating the probability of selection of the object contained by or described by the input.

2. The method of claim 1, wherein the neural network model is multiversally trained with the labeled dataset filtered to form a subset of the labeled dataset, and wherein the subset of the labeled dataset is used for fine-tuning the neural network model.

3. The method of claim 1, wherein the labeled training dataset is smaller than the unlabeled training dataset.

4. The method of claim 3, wherein the pre-training comprises bidirectional training by applying a missing words mask to the unlabeled dataset.

5. The method of claim 4, wherein the pre-training comprises training through sentence prediction.

6. The method of claim 1, wherein the fine-tuning comprises training through back-propagation.

7. The method of claim 1, wherein the selection probability estimate is obtained by taking the product of the likelihood of each class with the selection probability associated with the class, and the summation of the resulting products.

8. The method of claim 1, wherein the input is a text string, and wherein the feature extracted from the input is a text description of a website or application user interface object.

9. The method of claim 1, wherein the selection probability estimate is obtained by taking a dot product between the class selection probability vector and the classification result vector.

10. A non-transitory computer-readable medium comprising instructions executable by a processor to perform a method comprising steps of:
obtaining a multi-layer neural network by pre-training a neural network model with an unlabeled training dataset and fine-tuning the neural network model with a labeled dataset, the labeled dataset comprising data tagged with one or more classes;
receiving a user interface object description, or an image input or a video input of the object through a communication interface;
providing the input to the multi-layer neural network to obtain a classification vector, the classification vector having one or more entries, wherein each of the one or more entries is associated with a class of the feature; and
based on the classification vector, estimating the probability of selection of the object contained by or described by the input.

11. A system for estimating the probability of selection of a website or application user interface object by a human based on features extracted from an input from a user, the system comprising:
a communication interface for receiving the input from the user, the input comprising a description of a user interface object, or an image or a video therefor;
one or more memory storage for storing a neural network model, probability of selection estimate, the training data comprising an unlabeled training dataset and a labeled training dataset, the labeled dataset including data tagged with one or more classes; and
a processor configured to:
train the neural network model using the training data to obtain a multi-layer neural network, the neural network model trained in a pre-training step with the unlabeled training dataset and fine-tuned with the labeled training dataset;
provide the input to the multi-layer neural network to obtain a classification vector, the classification vector having one or more entries, wherein each of the one or more entries is associated with a class of the feature; and
based on the classification vector, estimate the probability of selection of a website or application object that was contained or described by the input.

12. The system of claim 11, wherein the processor is configured to multiversally filter the labeled dataset to obtain a subset of the labeled dataset, and wherein the subset of the labeled dataset is used in the fine-tuning of the neural network model.

13. The system of claim 12, wherein the labeled training dataset is smaller than the unlabeled training dataset.

14. The system of claim 13, wherein the pre-training step comprises bidirectional training by applying a missing words mask to the unlabeled dataset.

15. The system of claim 14, wherein the pre-training step further comprises training through sentence prediction.

16. The system of claim 13, wherein the fine-tuning of the neural network model comprises training through back-propagation.

17. The system of claim 11, wherein the input is a text string describing a user interface object, and wherein the feature extracted from the input is the probability of selection by a human of a user interface object described by the input text string.

18. The system of claim 11, wherein the selection probability estimate is obtained by taking a dot product between the class selection probability vector and the classification result vector.

19. The method of claim 1 comprising pre-training the neural network model with the unlabeled training dataset.
